(19) United States
(12) Patent Application Publication
(10) Pub. No.: US 2025/0244502 A1
(43) Pub. Date: Jul. 31, 2025

(54) METHOD FOR MODELLING THE FORMATION OF SEDIMENTARY DEPOSITION AND PERFORMING FACIES MODEL CONTROL

(71) Applicant: TotalEnergies OneTech, Courbevoie (FR)

(72) Inventors: Gérard Massonnat, Pau (FR); Martin Lemay, Pau (FR); Cédric Gal, Pau (FR); Emmanuelle Leonforte, Pau (FR)

(21) Appl. No.: 18/699,934

(22) PCT Filed: May 12, 2023
(86) PCT No.: PCT/IB2023/000258

§ 371 Date: Apr. 10, 2024

(51) Int. Cl. G01V 20/00

(52) U.S. Cl. CPC G01V 20/00

(57) ABSTRACT

A method for modelling sedimentary deposition within an immersed area includes receiving a sedimentary facies classification and a sedimentary environment classification, simulating the evolution of the topography of an immersed sedimentary area over time, comprising: defining a model of the immersed sedimentary area having a ground surface, a plurality of processes of supply or production of sediments, and at least one water current to be simulated, simulating the deposition of at least one layer of sediments on the ground surface within a time period, comprising: introducing particles of sediments into the model, transporting at least one particle by application of a water current including displacing or depositing the particle on the ground surface, recording data regarding the deposited particles, and updating the topography of the ground surface, and for at least one cell of a deposited layer of sediments, associating the cell to a sedimentary facies and a sedimentary environment.

### BACKGROUND

### Technical Field

The present disclosure relates to a computer-implemented method for modelling sedimentary deposition within an immersed area. It can be applied to analysis of sedimentary facies and sedimentary environments, in order to enable better interpretation of facies logs of observed wells.

### Description of the Related Art

Forward stratigraphic modelling is already known for modelling the evolution of sedimentary basins. In this type of modelling, an area is defined as a geological gridded model, and the modelling comprises superposing layers on the gridded model, each layer corresponding to a predetermined period of time and having a thickness which depends on an amount of material brought or created at a defined location during the period of time.

An example of forward stratigraphic modelling is for instance the DionisosFlow™ numerical stratigraphic model developed by IFP Energies Nouvelles, which allows reconstructing the stratigraphic architecture of sedimentary basins at a regional scale, by modelling basin deformation, clastic and carbonate supplies and sediment transport in continental and marine environment.

This model is used to simulate areas of regional scale, i.e., having dimensions of about tens to hundreds of kms side length², and on very long time scales. Each time layer simulated in this model is of at least 1000 years, up to 10,000 years, in order to model phenomena occurring on durations of at 100,000 years to several million years.

In order to be able to compute phenomena on such large geographical and time scales, the algorithms implemented by this model for simulating the transport of particles are only based on advection and diffusion. This implies that the geological phenomena which are simulated in forward simulators like DionisosFlow™ are necessarily continuous and homogeneous, and hence they cannot render local heterogeneities, which limits their potential for instance to precisely model the formation of reservoirs for hydrocarbon production or carbon storage.

On the other hand, some models also exist to simulate phenomena which are more localized both in time and space, such as snow avalanches, sedimentation dynamics within rivers and deltas, etc. These models are based on equations modelling the motion of fluids such as Navier-Stokes equations. These models require a high computational load as compared to the time scale of the modelled phenomena, since the modelling of a phenomena requires a computational time of 1.5 times the duration of the modelled phenomena. Hence these times of models are not suitable for modelling the formation of reservoirs.

It is also known from WO 2020/229863, WO 2020/229862, WO 2020/229866 and WO 2020/229865 methods for modelling the evolution of sedimentary basins by simulating current-induced particle transport. These methods are forward stratigraphic modelling methods enabling to model the deposition of time-layer of sediments corresponding to an amount of time that is less than the duration of a time-layer of DionisosFlow™, for instance between a few 100 years and a few 10,000 years. The methods disclosed in these documents allow modelling the transport of particles based on current transport and takes into account the possible interaction between several phenomena or several types of current transport.

These kinds of simulation provide a better understanding of the interaction between different phenomena and hence of the evolution of a sedimentary basin over a long period of time. However, it may remain difficult to rely on such simulation to reach a state corresponding to an observable reality or to interpret said reality. Indeed, well logs, that comprise successive layers or rock types of determined elements, associated to variable sedimentary features of the rock types, are conventionally interpreted by geologists to infer data such as:
the sedimentary facies composing the log, i.e., a particular type or rock that forms under specific conditions of sedimentation; and
sedimentary environments, that are the specific environmental conditions at the time of the deposition, impacting the formation of certain facies.

These data are not obtained by implementation of the above methods and hence the comparison between the outcome of the model and a facies log interpreted by a geologist cannot be readily performed.

### BRIEF SUMMARY

The present disclosure provides a method for modelling the formation of sedimentary deposition within an immersed area, said method being able to output sedimentary facies and sedimentary environment regarding a sedimentary deposition.

Accordingly, disclosed herein is a method for modelling sedimentary deposition within an immersed area, the method being implemented by a device comprising a computer and a memory, and comprising:
receiving a sedimentary facies classification comprising, for a plurality of sedimentary facies, a list of criteria defining each sedimentary facies, wherein said criteria comprise the elements and respective proportions of each element composing the sedimentary facies;
receiving a sedimentary environment classification comprising, for a plurality of sedimentary environments, a list of environmental parameters conditions defining the sedimentary environment;
simulating the evolution of the topography of an immersed sedimentary area over time, wherein said simulation comprises:
   defining:
      a model of the immersed sedimentary area comprising a ground surface having a plurality of cells and an initial topography;
      a plurality of processes of supply or production of sediments; and
      at least one water current to be simulated;
   simulating the deposition of at least one layer of sediments on the ground surface within a determined time period comprising:
      introducing a plurality of particles of sediments into the model according to the defined supply or production processes;
      simulating occurrence of the at least one water current;
      determining a transport of at least one particle introduced in the model resulting from the water current, wherein the transport comprises displacing or depositing the particle on the ground surface;
      recording data regarding the deposited particles in the memory, the recorded data comprising the type of element, volume and conditions of deposition of the deposited particles; and
      updating the topography of the ground surface; and for at least one cell of a deposited layer of sediments, associating the cell to:
   a sedimentary facies, based on a comparison between the recorded data and the sedimentary facies classification; and
   a sedimentary environment, based on a comparison between the recorded data and the sedimentary environment classification.

In embodiments, the list of criteria defining each sedimentary facies further comprises sedimentary features comprising:
a current structure;
a grain sorting; and
presence or absence of emersion traces,
wherein simulating an occurrence of at least one water current comprises determining a velocity of the current in a plurality of cells of the model, and
wherein the recorded data further comprises, for a cell, the velocity of each current occurring within the cell, the granulometry of the deposited particles, and a depth with respect to a water level of the cell, and associating the cell to a sedimentary facies comprises determining a current structure, grain sorting and presence or absence of emersion traces in the cell based on the recorded data.

In embodiments, the environmental parameters conditions defining a sedimentary environment comprise a condition on location of the sediments relative to the tide,
wherein at least one modelled current comprises a tidal current, modelling the tidal current comprises determining a high tide and a low tide water level, the recorded data for a cell comprise a water depth of the considered cell at high tide and at low tide,
and associating the cell to a sedimentary environment comprises determining a location of the cell relative to the tide based on the recorded data, and inferring the sedimentary environment based on said location.

In embodiments, the environmental parameters conditions defining a sedimentary environment comprise a condition on location of the sediments relative to waves,
wherein at least one modelled current comprises a wave-induced current, modelling the wave-induced current comprises determining a wave base water depth and a wave breaking water depth, the recorded data for a cell comprise an indication of the water depth in the cell being either:
   below wave-breaking water depth;
   between wave-breaking water depth and wave base water depth; or
   at or above wave base water depth,
and associating the cell to a sedimentary environment comprises determining a location of the cell relative to the waves based on the recorded data and inferring the sedimentary environment from said location.

In embodiments, the simulation further comprises simulating stormy events, and comprises defining a duration of stormy weather conditions during the determined time period, the rest of the time period corresponding to fair weather conditions, wherein simulating the deposition of a layer of sediments comprises:
determining wave base water depths and wave breaking water depths in fair weather and stormy conditions;
determining a transport of at least one introduced particle induced by wave-induced water current in fair weather conditions;
modelling remobilization of a fraction of the deposited particles following occurrence of stormy weather conditions; and
determining a transport of the remobilized particles induced by wave-induced water current in stormy weather conditions,
wherein the recorded data further comprise an indication of the water depth in the cell relative to wave base water depths and wave breaking water depths in fair weather and stormy conditions,
and associating the cell to a sedimentary environment comprises determining a location of the cell relative to the waves based on the recorded data and inferring the sedimentary environment from said location.

In embodiments, the environmental parameters conditions defining a sedimentary environment comprise a condition on a topographic slope at the location of deposition of the sediments, and the recorded data for a cell comprises the topographic slope of the ground surface at the cell.

In embodiments, the environmental parameters conditions defining a sedimentary environment comprise a condition on a bathymetry of the location of deposition of the sediments,
simulating the deposition of a layer of sediments comprises computing a water depth of a cell based on a water level and the topography of the ground surface, and the recorded data for a cell comprises said water depth,
and associating the cell to a sedimentary environment comprises determining a bathymetry of the cell based on the recorded water depth.

In embodiments, the environmental parameters conditions defining a sedimentary environment comprise a condition on energy of water currents occurring at the location of deposition of the sediments,
wherein simulating an occurrence of at least one water current comprises determining a shear stress induced by said at least one water current in a plurality of cells of the model, the recorded data comprise said shear stress, and associating the cell to a sedimentary environment comprises determining an energy of water currents in the cell from the recorded shear stress.

In embodiments, the method further comprises computing a spatial distribution of at least one sedimentary facies within the model, based on the cells associated to said sedimentary facies.

In embodiments, the method being implemented by a device also comprising a display, and the method further comprises displaying one of a three-dimensional sedimentary facies map and a three-dimensional sedimentary environment map of the model in at least one state corresponding to a respective time.

In embodiments, the method further comprises determining correlation between at least one sedimentary facies and at least one sedimentary environment.

In embodiments, the method further comprises computing transition probabilities between vertically adjacent sedimentary facies within the model.

In embodiments, the method further comprises receiving a facies log corresponding to an observed well and comparing the computed transition probabilities between vertically adjacent facies within the model to the transitions between vertically adjacent facies of the facies log.

Further disclosed herein is a computer program product comprising code instructions for implementing the method according to the description above, when the instructions are executed by a processor.

Also disclosed herein a non-transitory computer readable storage medium, having stored thereon a computer program comprising program instructions, the computer program being loadable into a processor and adapted to cause the processor to carry out, when the computer program is run by the processor, the method according to the description above.

In addition, disclosed herein a computing device comprising:
an input module for receiving:
   a sedimentary facies classification comprising, for a plurality of sedimentary facies, a list of criteria defining each sedimentary facies, wherein said criteria comprise the elements and respective proportions of each element composing the sedimentary facies; and
   a sedimentary environment classification comprising, for a plurality of sedimentary environments, a list of environmental parameters conditions defining the sedimentary environment;
a simulation module configured for simulating the evolution of the topography of an immersed sedimentary area over time, comprising:
   defining:
      a model of the immersed sedimentary area comprising a ground surface having a plurality of cells and an initial topography;
      a plurality of processes of supply or production of sediments; and
      at least one water current to be simulated;
   simulating the deposition of at least one layer of sediments on the ground surface within a determined time period comprising:
      introducing a plurality of particles of sediments into the model according to the defined supply or production processes; and
      simulating occurrence of the at least one water current; and
   determining a transport of at least one particle introduced in the model resulting from the water current, wherein the transport comprises displacing or depositing the particle on the ground surface;
a memory configured for recording data regarding the deposited particles in the memory, the recorded data comprising the type, volume and conditions of deposition of the deposited particles; and
a quality control module configured to associate, to at least one cell of a deposited layer of sediments:
   a sedimentary facies, based on a comparison between the recorded data and the sedimentary facies classification; and
   a sedimentary environment, based on a comparison between the recorded data and the sedimentary environment classification.

In embodiments, the quality control module is further configured to compute correlations between sedimentary facies and sedimentary environments or environmental parameters conditions defining a sedimentary environment, and the device further comprises a display for displaying said correlations.

### BRIEF DESCRIPTION OF THE SEVERAL VIEWS OF THE DRAWINGS

The present disclosure is illustrated by way of example, and not by way of limitation, in the figures of the accompanying drawings, in which like reference numerals refer to similar elements and in which:

FIG. 1 is a flow chart schematically describing the main steps of a method according to an embodiment;

FIG. 2 is a representation of the decomposition of an immersed area into three water depths ranges;

FIG. 3 schematically represents the wind-induced currents and the evolution of their velocities according to water depth;

FIG. 4a represents a vertical profile of current velocity in the plume and subsurface layers;

FIG. 4b represents a vertical profile of shear stress in the plume and subsurface layers;

FIG. 5a represents the value of an avalanche angle as a function of grain size;

FIG. 5b represents the gravity-induced shear stress as a function of granulometry and topographic slope;

FIGS. 6a to 6d represent Shields diagrams showing whether a particle is deposited or transported according to its size and the shear stress applied to the particle, for four types of particles;

FIGS. 6e to 6h represent Shields diagrams showing whether a particle is remobilized according to its size and the shear stress applied to the particle, for four types of particles;

FIGS. 7a to 7d represent controlling factors for flocculation process;

FIG. 8 represents the distribution of particles before and after modelling a flocculation process;

FIG. 9a is a three-dimensional representation of the sedimentary facies associated to an exemplary reservoir;

FIG. 9b is a three-dimensional representation of the sedimentary environment associated to the exemplary reservoir of FIG. 10a;

FIG. 9c represents is an exemplary display of contingency statistics between sedimentary facies and sedimentary environments in the reservoir of FIG. 10a;

FIG. 9d represents sedimentary facies distribution of the reservoir of FIG. 10a;

FIG. 9e represents a vertical transition probability between the sedimentary facies of the reservoir of FIG. 10a;

FIG. 9f represents boxplots of environmental conditions applicable to sedimentary facies; and

FIGS. 10a and 10b represent possible embodiments of a computing device for implementing the method for modelling sedimentary deposition.

### DETAILED DESCRIPTION

As used herein, “sedimentary facies” denotes a volume of rock that is distinguished based on particular physical characteristics such as color, texture, constituent type (e.g., fossils, fragments) and sedimentary structures. Sedimentary facies represent the result of a specific depositional “sub”-environment. Nevertheless, the environmental interpretation for a facies is not necessarily unambiguous. In order to establish the depositional setting of a sedimentary facies, it is usually frames within a facies association (e.g., Walker 1992, D'Argenio, et al. 1997).

As used herein, “sedimentary environment” is a zone exhibiting specific environmental features (for instance in terms of bathymetry, energy, salinity, temperature, etc.).

As used herein “facies model” is a model defining all the facies and their spatial organization within a given sedimentary environment. A facies model can be built at a given hypothetical time in 2D or in 3D, in which case it is specific to a given evolution of the accommodation space, carbonate production, and environmental conditions.

“Facies model quality check” or “QC” is the task of checking the adequacy between a theoretical facies model and a simulated facies model based on the spatial organization of the facies and its evolution in time, and on the presupposed relationships between sedimentary facies and sedimentary environment.

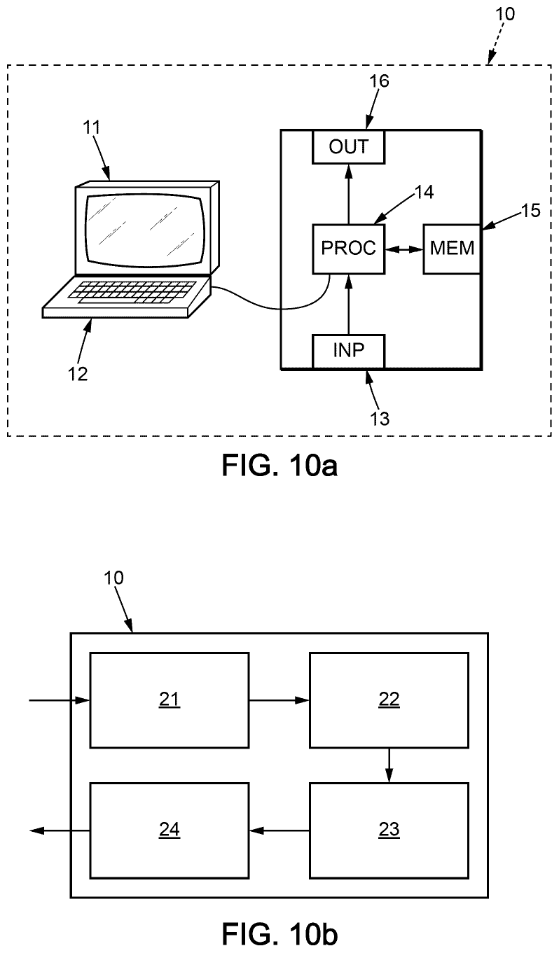

With reference to FIGS. 10a and 10b, the method for modelling sedimentary deposition described below is implemented using a computing device 10.

The computing device 10 comprises a computer, comprising a memory 15 to store program instructions loadable into a circuit and adapted to cause circuit 14 to carry out the steps of the present disclosure when the program instructions are run by the circuit 14. The memory may comprise a Read-Only (ROM) memory, such as an Electrically Erasable Programmable Read-Only Memory (EEPROM), or a Random Access (RAM) memory, or any other type of memory enabling the reading of code instructions.

The memory 15 or a distinct memory therefrom, may also store data and useful information for carrying the steps of the present disclosure as described below. In particular, the memory 15 may store a sedimentary facies classification and a sedimentary environment classification described in more details below, and may also store relevant data generated during simulation and used to infer sedimentary facies and sedimentary environment for the sedimentary depositions formed according to the simulation, as disclosed below. In this case the memory may be rather by a RAM memory, a magnetic hard disk, a solid-state disk, optical disk, electronic memory or any type of computer-readable storage medium enabling writing and updating stored data.

The circuit 14 may be for instance:
a processor or a processing unit adapted to interpret instructions in a computer language, the processor or the processing unit may comprise, may be associated with or be attached to a memory comprising the instructions, or
the association of a processor/processing unit and a memory, the processor or the processing unit adapted to interpret instructions in a computer language, the memory comprising said instructions, or
an electronic card wherein the steps of the disclosure are described within silicon, or
a programmable electronic chip such as a FPGA chip (for «Field-Programmable Gate Array»).

This computer comprises an input interface 13 for the reception of several data used for the method disclosed below, for instance the definition of the gridded model, and parameters relative to the simulation (parameters relative to the topography, the simulated currents, the supply or production processes, etc.). The input interface may also be configured for receiving a sedimentary facies classification and a sedimentary environment classification.

The computing device also comprises an output interface 16 for outputting the updated geological gridded model.

To ease the interaction with the computer, a screen 11, and a keyboard 12 or a tactile screen may be provided and connected to the computer circuit 14. The various components described above may be remotely connected to one another, i.e., the memory storing the data and/or the circuit implementing the method may be remotely located with reference to the user and accessible through any suitable network. The input interface 13 may comprise the screen, tactile screen and/or keyboard or any other input means collectively, and the output interface may also comprise the screen.

According to a functional representation of the computing device 10 represented schematically in FIG. 10b, the computing device may comprise an input module 21 for receiving a sedimentary facies classification and a sedimentary environment classification. The input module may comprise a Human-Machine Interface for receiving selection of a user regarding pre-defined classification or receiving user input for defining said classifications.

The computing device also comprises a simulation module 22 for performing the simulation detailed below of the deposition of sediments in an immersed sedimentary area over time, and a memory 23 for recording relevant parameters and data computed by the simulation module during the simulation. The computing device may also comprise a quality control module 24 configured to associate the cells of the modelled area to sedimentary facies and sedimentary environments according to the respective classifications, and to perform analysis and/or display regarding the obtained structure of sedimentary facies and sedimentary environments.

The method described below models the evolution of sedimentary basins by simulating the deposition over time of sediments such as siliciclastic and/or carbonates particles that can be supplied or produced by diverse processes such as rivers, travertine sources, in-situ production of carbonates, remobilization of carbonates, etc. This method also takes into account the impact of water currents on the transport of clastic and carbonates particles. The sedimentary area to be modelled can be either a marine area, or a lacustrine area.

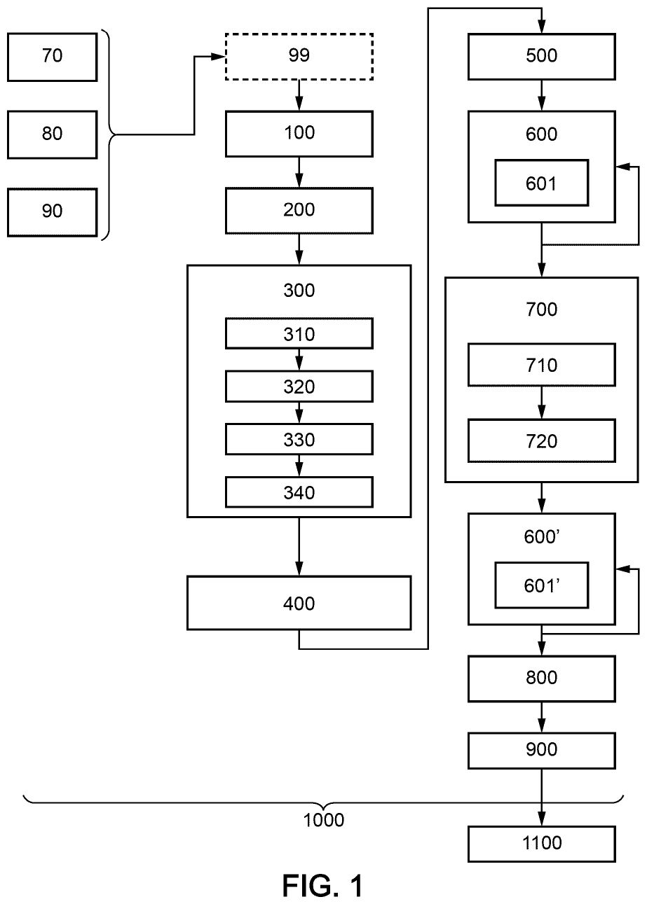

The method is a forward stratigraphic modelling method, modelling the evolution of an immersed sedimentary area through the deposition of successive layers of sediments. Accordingly, the sedimentary area is formed by a stack of layers, wherein each layer is defined by a two-dimensional surface representing the surface of the ground of the immersed area at the time of deposition of sediments, and by a thickness of sediments forming said layer. Each layer is gridded and comprises, like in the example shown in FIG. 1, a plurality of grid cells M_{1,1}, M_{1,2}, M_{2,1}, and more generally M_{i,j}, where the variables i and j indicate the positions of the cells within the surface. Each layer if further associated to a time t corresponding to a time of deposition of sediments. Accordingly, each cell of the modelled area can be described by three parameters (i, j, k) or (x, y, t) wherein the two first coordinates represent the location of the cell within the surface and k represents the time layer or t represents the time of formation of the surface, which is equivalent.

Typically, each cell represents an area having a side length of a few hundreds of meters, up to a few kilometers. The method starts with an initial topography corresponding to an initial surface representing the bottom of the immersed area, above which a column of water of defined height (i.e., water depth of each cell of the model) is defined, and comprises iterating a series of steps modelling the introduction into the model of clastic and/or carbonates particles during a predetermined period of time T, their transport induced by water currents during this period of time T, and the deposition of some of these particles to form an additional layer of sediments.

At the end of this period of time T, the topography of the model is updated in each cell according to the quantity of deposited particles. More specifically, a layer is generated, which thickness in each cell is determined based on a number of particles deposited at this cell. Such a layer is called a time layer since it corresponds to the passage of the predetermined period of time T. The topography of the geological gridded model of the area thus evolves with the accumulation of time layers.

The method disclosed below further correlates the parameters computed during the simulation and resulting in the topological evolution of the concerned area, with parameters defining sedimentary facies and sedimentary environments, in order to output three-dimensional and even four-dimensional (3D+time) maps of sedimentary facies and establish correlations between sedimentary facies and sedimentary environments.

The method thus enables performing a facies model quality check in order for instance to correct a facies model elaborated based on observations and studies of a sedimentary basin, or to correct hypotheses on which the simulation is based. The method may be implemented for enhanced modelling of a sedimentary basin, for instance with a view to at least one of the following applications: hydrocarbon recovery, carbon dioxide storage, civil engineering, groundwater resources management, urbanism, agriculture.

### Setup Step

The method for modelling the evolution of a sedimentary area comprises a first preliminary setup step 70.

The setup step comprises initializing a topography of the modelled area, i.e., receiving an initial surface having a plurality of cells wherein each cell corresponds to a position (x,y) and is assigned a parameter z₀ which is the height of said bottom surface.

The setup step also comprises setting an initial reference water level zᵣ, as well as the evolution of the reference water level over the model between two successive periods of time T, i.e., two successive time layers (eustatism for marine areas) and the amount of subsidence of the ground's surface over the geological gridded model between two time layers. The amount of subsidence may vary over the model of the area, i.e., it may not be the same for all the cells of the models.

From the initial topography of the geological gridded model and the initial reference water level, a water depth WD in each cell is inferred and assigned to the respective cell. If the height z₀ of a cell is above the reference water level zᵣ, then the water depth is zero. It can be understood that, as the method aims at modelling the evolution of a sedimentary area, at least some of the cells of the initial topography are below water level, i.e., z₀<zᵣ.

The setup step 90 also includes the user defining the number and types of particles supply or production processes, the number and types of water currents to be modelled, and the parameterizing of each particle supply or production process and of each current.

Regarding the particles supply or production processes, each particle introduced within the model may result from either a carbonate production model or a siliciclastic supply process.

Carbonates production processes comprise:
carbonates from underwater factories;
carbonates from subaqueous thermal springs; and
aerial travertine.

Siliciclastic supply processes comprise:
river mouth supply; and
volcanoes supply.

The parameterization of production of carbonates may comprise defining a sedimentary element type, granulometry, and production rate of the carbonate production. The production rate may itself depend upon environmental factors which may also be set by the user, such as bathymetry, current energy, water temperature, chemistry, etc.

The parameterization of each siliciclastic supply process may comprise defining a location of the source of elements (location of the volcano, river mouth, etc.) sedimentary element type, granulometry, and rate of supply of the considered process, i.e., a volume or mass of supplied sedimentary elements per time unit.

During the subsequent modelling of the supply or production processes, the sedimentary elements are introduced in the model as particles where each particle represents a determined mass or volume of siliciclastic or carbonates sediments of a defined granulometric class.

Regarding the currents to be modelled, the user may choose to model at least one among the following water currents:
wind-induced current, including wind-induced wave current and oceanic surface current;
tidal current; and
river-mouth induced current.

Oceanic surface current can only apply for marine areas, whereas the other currents, including tidal current, can apply for both marine and lake areas. If wind-induced currents are modelled, then the setup step also comprises setting up a celerity vector of the wind \vec{u_{wind}}, comprising setting a direction and an absolute value of the wind celerity.

If at least one river mouth induced current is to be modelled, the setup step 90 can comprise the user setting the volumetric flow of the river at the river mouth, the width and depth of the river mouth.

In embodiments, the modelling of evolution of a sedimentary area may also comprise simulating exceptional weather events, i.e., storms, floods, etc., that are prone to remobilizing sediments that have already been deposited. In these embodiments, the setup step 90 also comprises defining a duration of stormy conditions over the time period T, expressed for instance as a number of days of stormy conditions per year. If wind-induced currents are modelled, a celerity vector of the wind \vec{u_{wind,storm}} in stormy conditions may also be defined during this setup step. By contrast, in these embodiments, the celerity vector of the wind \vec{u_{wind}} introduced above relates to the parameters of the wind in fair weather conditions, i.e., during the rest of the days of the year.

The method also comprises receiving 80 a sedimentary facies classification comprising, for a plurality of sedimentary facies, a list of criteria defining each sedimentary facies. According to an embodiment, at least one sedimentary facies classification may be preliminary defined and stored in a memory of the computing device and is then accessed during the next steps. If a plurality of sedimentary facies classifications are preliminary defined, the user may select one classification among the plurality of pre-defined classifications. According to another embodiment, part or all of the sedimentary facies classification may be defined by a user using the input interface 13.

In any case, a sedimentary facies classification comprises, for each of a plurality of sedimentary facies, a name or identifier of each sedimentary facies, and a list of criteria defining each sedimentary facies.

The list of criteria defining each sedimentary facies may comprise at least a list of elements entering in the composition of the facies, the respective proportions of said elements, and, for carbonates elements, a condition about the origin of said element, i.e., whether the considered element has to have been produced in place or transported (after remobilization due to stormy events) or can originate from both in-situ production and transport.

In embodiments, the list of criteria defining each facies may further comprise sedimentary features of the selected facies. The sedimentary features may include a current structure that is a footprint of the velocity of currents occurring at the location and time of deposition of the sediments. The sedimentary facies may be associated to a current structure by selecting one type of current structure among a predefined list, including for instance the following structures:
No structure,
Laminated,
Current ripples,
Dunes, and
Antidunes.

The current structure of a facies may be inferred from current velocity, i.e., each current structure may be associated to a range of velocity values of water current occurring at the time and location of deposition of the sediments.

The sedimentary features may also comprise a level of grain sorting within the facies, i.e., a level of homogeneity of the granulometry of the elements composing the facies. The level of grain sorting may be selected by a user among a plurality of predefined levels of sorting including for instance:
Very poorly sorted,
Poorly sorted,
Moderately sorted,
Well sorted, and
Very well sorted.

The sedimentary features may also comprise a condition relative to presence or absence of emersion trace, i.e., whether the sediments have been emerged during a determined duration. The user may for instance associate the sedimentary facies to the fact that emersion traces must be present or must be absent.

The list of criteria defining each facies may comprise any combination or all of the conditions recited above, and the list of criteria defining one facies may be different from the list of criteria defining another facies.

The method also comprises receiving 90 a sedimentary environment classification comprising, for a plurality of sedimentary environments, a list of environmental parameters conditions defining each sedimentary environment. According to an embodiment, the sedimentary environment classification may be preliminary defined and stored in a memory of the computing device and is then accessed during the next steps.

According to another embodiment, part or all of the sedimentary environment classification may be defined by a user using the input interface 13.

In any case, a sedimentary environment classification comprises, for each of a plurality of sedimentary environments, a name or an identifier of the sedimentary environment, and a list of environmental parameters conditions defining the sedimentary environment.

The list of environmental parameters conditions may comprise a condition on bathymetry of the considered sediments, i.e., the depth under water of the sediments at the time and location of their deposition. A condition on bathymetry may be set as a range of water depths associated to a given sedimentary environment.

The list of environmental parameters conditions may comprise a condition on water temperature, pH, salinity, or any other chemical parameter (such as a concentration of a given chemical species) at the time and location (cell) of the sediment deposition. A condition of one of these parameters may be set as a range of values of said parameter associated to a given sedimentary environment.

The list of environmental parameters conditions may comprise a condition on slope of the considered sediments, i.e., the slope of the surface of deposition of the sediments at the time and location (cell) of deposition. A condition on slope may be set as a range of slope values associated to a given sedimentary environment.

The list of environmental parameters conditions may comprise a condition on energy of water currents occurring at the time and location of sediment deposition. A condition on energy of water currents associated to a given sedimentary environment may be expressed as a range of shear stress values induced by water currents.

The list of environmental parameters conditions may comprise, when wind-induced currents are modelled, a condition on location of the sediments relative to the waves occurring at the time of deposition. This condition may be selected among a plurality of predefined locations which are defined with respect to the action of the waves. In particular, as disclosed in more details below, modelling wind-induced currents includes determining a wave-base water depth, which is the water depth at which the wind produces a current, and a wave-breaking water depth, and the condition on location of the sediments relative to the waves may be expressed as a condition on water depth with respect to said wave base water depth and wave breaking water depth. When the simulation includes modelling stormy events, the classification may also include locations which are defined with respect to wave base water depth and wave breaking water depth corresponding to stormy events.

According to a non-limiting embodiment, the condition on location of the sediments relative to the wave may be a location selected among the following group:
Offshore—corresponding to WD<Wave base water depth during stormy events;
Shoreface—corresponding to WD>wave base water depth during stormy events and during fair weather; which may further be specified between:
   upper shoreface—WD>Wave breaking water base in fair weather conditions; or
   lower shoreface—WD<wave breaking water base in fair weather conditions; and
Shoreface/offshore transition—corresponding to a WD comprised between storm and fair weather wave base water depths.

The list of environmental parameters conditions may comprise, when tidal current is model, a condition on location of the sediments relative to the tide, and may be selected among a plurality of predefined choices such as, for instance:
Supratidal, which corresponds to a height above sea level at high tide;
Inter tidal, which correspond to a height which is above sea level at low tide but below sea level at high tide; or
Infra tidal, which corresponds to a height below sea level at low tide.

The list of environmental parameters conditions may comprise any combination or all of the conditions recited above, and the set of environmental parameters conditions defining one sedimentary environment may be different from the set of environmental parameters conditions determining another sedimentary environment.

Preferably, whether the steps of receiving the classifications 80, 90 are performed after or before the setup step, the relevant parameters defining the classifications are consistent with the modelled phenomena of the simulation. For instance, some sedimentary facies or sedimentary environments present in a respective classification may not be available for association if the relevant parameter for determining the sedimentary facies or environment was not modelled during simulation. According to a non-limiting example, a sedimentary environment comprising a condition on location of the sediments relative to the tide may not be determined or associated to a cell if tidal current was not modelled.

The method then comprises a series of steps which are detailed below, and which are implemented to generate one time layer, representing the passage of the predetermined period of time T. The duration of the period of time T may also be set by the user during the setup step. Preferably, this duration may be comprised between 1000 and 100,000 years.

### Computation Layer

The series of steps which forms one computation layer, and which is implemented at least once to generate a time layer, or iterated a number N of times in the embodiments described above, is designated by reference 1000 on FIG. 1, and will now be described.

An optional preliminary step 99 comprises the change of some parameters of the model by the user, if it is desired to represent an evolution of these parameters between one period of time represented by a time layer T and another. For instance, the parameters regarding the river mouth current that can be set at step 90 (volumetric flow, width and height at the river mouth) can be modified at step 99. Also, the parameterization of each supply or production process may be changed at optional step 99.

The eustatism and subsidence rate may also be amended between two time-layers during said preliminary step 99.

Step 100 comprises receiving the geological gridded model of the area, either by loading an initial version of the model, or by updating the model according to a previous iteration of the series of steps 1000. The update comprises updating a height along z of each cell, which corresponds to the initial position z₀ of the cell along z added to the thickness of particles deposited at the cell. The height along z may also take into account local subsidence of the ground's surface.

The method then comprises a step 200 of computing, from the topography updated at step 100, topographic slopes of the ground surface formed by the model and inferring, from the topography and reference water level zᵣ, the water depth WD in each cell.

The method then comprises a step 300 of modelling marine water currents occurring over the immersed area represented by the gridded model. This step is performed by determining, for a plurality of cells of the gridded model for which WD>0, and preferably each cell for which WD>0, a direction and velocity of each water current to be modelled. The shoreline SL is defined by cells for which WD=0 and which are adjacent cells for which WD>0.

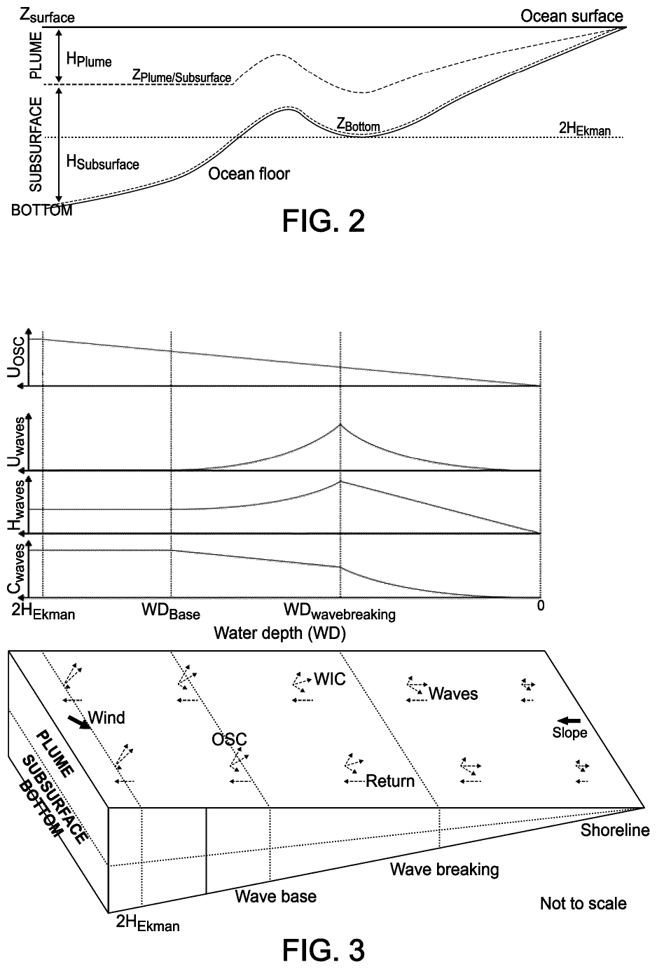

For the computation of direction and velocity of each water current, and with reference to FIG. 2, the extent of water extending over the ground surface is decomposed into three water layers or respective depths, comprising a bottom layer, extending at water bottom, a plume layer, extending at water surface, and a subsurface layer extending between the plume layer and the bottom layer.

More specifically, the thickness of the bottom layer is constant and corresponds to the boundary layer for the subsurface flow. It is preferably comprised between a few mm and a few cm. It may be set by the user or defined per default. According to a non-limiting example, the thickness of the bottom layer may be set equal to 0.01 meter. The bottom layer thus extends between the ground surface and a fixed distance thereof.

The thickness of the plume layer is determined based on the thickness of Ekman layer. Ekman layer is the layer in a fluid where there is a force balance between pressure gradient force, Coriolis force and turbulent drag. The thickness of the Ekman layer depends upon the latitude and is expressed as follows:

$${H}_{E k m a n} = \{ \begin{matrix}π \sqrt{2 {A}_{z} / \vert f \vert} if ϕ \geq 7.7 ° \\ 100 if ∅ \leq 7.7 °\end{matrix}$$

where A_{z}=0.01 m²/s, f=Ω·sin(Φ) and Ω=7.3.10⁻⁵ rad/s.

The thickness of the plume layer, i.e., the limit between the plume and subsurface layer, is set to be at most equal to H_{Ekman} computed above if the water depth in a given cell is at least 2H_{Ekman}. Otherwise, the thickness of the plume layer is equal to WD/2 as summarized below:

$${z}_{plume / subsurf} = \{ \begin{matrix}{z}_{surface} - {H}_{Ekman} if WD \geq 2 {H}_{Ekman} \\ {z}_{surface} - \frac{WD}{2} if WD \leq 2 {H}_{Ekman}\end{matrix}$$

An example of decomposition into three water layers depending on the water depth of the ground surface and the thickness of the Ekman layer is shown in FIG. 2.

Computing 300 the direction and velocity of currents occurring within the immersed area thus comprises determining 310 the thickness of the Ekman layer, decomposing the water into three water layers 320, and then determining 330 a direction and velocity of currents occurring within the plume layer, and within the subsurface layer. In the bottom layer, the velocity of currents is not computed since it is considered as the boundary layer of the subsurface current.

As indicated above, one or more currents may be simulated among: wind-induced currents, which comprise ocean surface current and wave-induced current, river-mouth current and tidal current. Accordingly, a celerity vector may be determined for each current in the plume and subsurface layer.

The celerity vector of the wind-induced currents in the plume layer \vec{U_{WIC,plume}} is the sum of the celerity vectors of the ocean surface current \vec{U_{OSC,plume}} and the wave-induced current \vec{U_{waves,plume}}:

$$\vec{{U}_{WIC , plume}} = \vec{{U}_{OSC , plume}} + \vec{{U}_{waves , plume}}$$

Ocean surface current is the current induced in the water surface by the wind, inducing a water displacement within the Ekman layer.

In the plume layer, the direction of displacement of water induced by the ocean surface current (hereinafter denoted “OSC” in indexes) is perpendicular to the direction of the wind, towards the right (i.e., clockwise direction) in the Northern hemisphere and towards the left (i.e., counter-clockwise direction) in the Southern hemisphere:

$$\vec{{U}_{OSC , plume}} = \{ \begin{matrix}\vec{{U}_{{OSC}_{0}}} = \pm \frac{{ρ}_{air} {C}_{f} {\vert {u}_{wind} \vert}^{2}}{{ρ}_{w} \cdot f \cdot {H}_{Ekman}} \cdot ( - {Dir}_{{wind}_{y}} , {Dir}_{{wind}_{x}} ) if WD \geq 2 {H}_{Ekman} \\ \vec{{U}_{{OSC}_{0}}} \cdot \frac{WD}{2 {H}_{Ekman}} if WD \leq 2 {H}_{Ekman}\end{matrix}$$

where Dir_{wind}_{ₓ} and Dir_{wind}_{_{y}} are the coordinates in x and y of the wind speed vector, ρ_{w} and ρₐᵢᵣ are the volumetric masses of water and air, respectively, in kg/m³, C_{f}=0.0015 is the friction coefficient of water surface. The norm of the vector U_{OSC,plume} is the velocity value of the OSC current in the plume layer in a considered cell. It is an average value over the thickness of the plume layer.

In the plume layer, the wave-induced current is parallel to the direction of the wind and only occurs from the surface down to a determined depth WD_{Base} called wavebase water depth, so by definition this wave-induced current only occurs in cells in which the water depth WD is below WD_{Base}. WD_{Base} may be computed as follows:

$$W {D}_{B a s e} = \frac{{λ}_{w a v e}}{2}$$

where λ_{wave} is the wave wavelength induced by the wind and may be inferred from the wind speed by use of a wave model such as the Airy linear model.

A wave breaking water depth is also defined as:

$${WD}_{wavebreaking} = \frac{{λ}_{wave}}{20}$$

When stormy events are simulated these parameters have to be computed for both stormy and fair weather conditions. The velocity of the wave-induced current is computed from the height of the waves and the celerity of the waves.

The height of the waves is computed as follows:

$${H}_{waves} = \{ \begin{matrix}{H}_{{waves}_{0}} = \frac{2 {C}_{{waves}_{0}}^{2}}{9 g} if WD = {WD}_{Base} \\ {H}_{{waves}_{0}} \cdot \sqrt{\frac{{C}_{{waves}_{0}}}{{C}_{waves}}} if {WD}_{wavebreaking} \leq WD \leq {WD}_{Base} \\ \begin{matrix}linear interpolation between {H}_{{waves}_{0}} \cdot \\ \sqrt{\frac{{C}_{{waves}_{0}}}{{C}_{waves}}} and 0 if WD \leq {WD}_{wavebreaking}\end{matrix}\end{matrix}$$

The celerity of the waves is computed as follows:

$${C}_{waves} = \{ \begin{matrix}{C}_{{waves}_{0}} = {U}_{wind} if WD - {WD}_{Base} \\ \sqrt{g \cdot WD} if WD \leq {WD}_{wavebreaking} \\ \begin{matrix}linear interpolation between {C}_{{waves}_{0}} and \sqrt{g \cdot {WD}_{wavebreaking}} if \\ {WD}_{wavebreaking} \leq WD \leq {WD}_{Base}\end{matrix}\end{matrix}$$

The velocity vector of the wave induced current is thus null is WD>WD_{Base} and equal, when WD≤WD_{Base} to:

$$\vec{{U}_{waves , plume}} = \frac{{gH}_{waves}^{2}}{8 \cdot WD \cdot {C}_{waves}} \vec{D i {r}_{wi nd}}$$

The norm of the vector U_{waves,plume} is the velocity of the wave-induced current in the plume layer in a considered cell. It is an average velocity over the thickness of the plume layer. Additionally, when the water depth WD is below twice the thickness of the bottom water layer, the velocity of the wave-induced current is set to zero to prevent numerical divergence.

FIG. 3 provides a summary of the ocean surface current velocity and wave induced current velocity in the plume layer.

In embodiments, the modelling of wind-induced currents may also comprise modelling a fetch distance. Indeed, the waves are formed only when the wind blows on wide enough areas. Thus when the wind blows from the sea towards the shore line, it is considered that the wave-induced current and oceanic surface current appear in all the cells until the shoreline according to the above equations. When by contrast the wind blows from the shoreline towards the sea, a fetch distance is computed from the shoreline, which value is defined by:

Fetch=0.20·U_{wind}^{0.57}

If the water depth of the cells is lower than WD_{base} from the shoreline to the fetch distance, the celerity of the waves linearly increases from 0 on the shoreline until Uwaves computed according to the equation above at the fetch distance. If the water depth is higher than WD_{base} then the wave celerity is null.

Regarding the ocean surface current, the latter increases linearly from 0 at the shoreline until reaching the velocity U_{OSC} computed according to the equation above at the fetch distance.

Regarding wind-induced currents, the direction and velocity of these currents in the subsurface layer can be inferred at substep 340 from the direction and velocity respectively of the currents in the plume layer.

In the subsurface layer, with reference to FIG. 3, the wind-induced currents are return currents (denoted \vec{U_{return,subsurface}}) from the wind-induced currents occurring in the plume layer.

Accordingly, the velocity vectors of said return currents extend parallel to the topographic slope in the considered cell, i.e., the vector of maximum slope of the ground surface in the cell, and in a direction opposed to the direction of the component of the respective velocity vector of the wind induced currents within the plume layer that is parallel to the slope.

The subsurface velocity vector is thus inferred from the component of the velocity of the wind-induced currents in the plume layer which is parallel to topographic slope as follows,

$$\vec{{U}_{return , subsurface}} = - \vert \vec{{U}_{WIC}} \cdot \vec{Slope} \vert \cdot \vec{D i {r}_{WIC , slope}} \cdot \frac{{H}_{plume}}{{H}_{subsurface}}$$

\vec{Slope} is the unitary vector of maximum descending slope in the considered cell, and \vec{Dir_{WIC,slope}} is the direction of the component of \vec{U_{WIC}} parallel to the topographic slope.

If, in addition to the wind-induced currents, the modelled currents also comprise a river-mouth induced current and/or a tidal current, then:
the directions and velocities of the river-mouth induced current in the plume and in the subsurface layers may also be determined by implementing the method disclosed in WO 2020/229865.

In particular, the velocity of a river-mouth induced current depends on the sedimentary charge distribution of the river and the position of the considered cell with respect to the width of the river jet. The sedimentary charge distribution may be either homopycnal, hypopycnal and hyperpycnal and may be determined based on a comparison between the density of the water brought by the river and the density of the water in which the river flows. The velocity vector of river-mouth induced current extends perpendicular to the direction along which extends the width of the river mouth, and extending away from the river mouth, and the velocity of the current Uᵣᵢᵥₑᵣ is denoted as u in WO2020/229865.

The direction and velocity of the tidal current, as well as the water level at high tide and low tide, may also be determined by implementing the method disclosed in WO 2020/229866.

In particular, as developed in this document, modelling the tidal current implies defining a high-tide water level Z_{HT} and a low-tide water level Z_{LT}, which can be defined as follows:

$${Z}_{HT} = {Z}_{r} + \frac{{H}_{TR}}{2}$$

$${Z}_{LT} = {Z}_{r} - \frac{{H}_{TR}}{2}$$

where zᵣ is the reference water level and H_{TR} is the tidal range, which may be deduced by a tidal range class set by the user.

Modelling the tidal current also implies decomposing each time layer into an even number of 2 k computation layers corresponding to subperiods of time of duration T/2 k where half of the subperiods correspond to rising tide and the other half corresponds to the falling tide. The direction of the tidal current is towards the shoreline during rising tide and away from the shoreline during falling tide. The velocity of the tidal current U_{tidal} in the plume layer increases from 0 at the high tide shoreline to a maximum value (which may be user-defined) at a distance from the shoreline such that WD=zr in the cell, and then decreases again until reaching 0 in cells where WD=WD_{TD} where WD_{TD} is the water depth of influence of the tidal current. The velocity of the tidal current in the subsurface layer is computed from the velocity of the tidal current in the plume layer of the same cell by applying a decrease factor which is function of water depth.

The method then comprises determining 400 a direction and intensity of shear stress induced by the modelled water currents in each water layer. The intensity of a shear stress in a water layer is a depth-averaged intensity over the height of said water layer. It is thereafter denoted:
\vec{τₚₗᵤₘₑ} a shear stress induced by simulated currents on particles in the plume layer;
\vec{τ_{subsurface}} a shear stress induced by simulated currents on particles in the subsurface layer; and
\vec{τ_{bottom}} a shear stress in the bottom layer, which is induced as explained below by the simulated currents and also the slope of the bottom. The part of shear stress in the bottom layer only induced by water currents is denoted \vec{τ_{bottom,cur}}.

The shear stress in a water layer is the sum of the shear stresses induced in that water layer by the simulated currents. For instance, when the simulated currents include wind-induced currents, river-mouth current and tidal current, the shear stress in the plume layer is computed as follows:

$$\vec{{τ}_{plume}} = \vec{{τ}_{WIC , plume}} + \vec{{τ}_{river , plume}} + \vec{{τ}_{tidal , plume}}$$

$$where$$

$$\vec{{τ}_{wic , plume}} ( z ) = \vec{{τ}_{waves , plume}} ( z ) + \vec{{τ}_{OSC , plume}} ( z )$$

The depth-average shear stress induced by a water current in a water layer is determined from a shear stress profile according to depth, which is itself determined from a velocity profile of the water currents as a function of water depth in said layer.

Regarding the wind-induced currents, i.e., the wave-induced current and the ocean surface current, each velocity profile in the plume layer is a power law profile, wherein the velocity is maximum at the surface and becomes null at the interface between the plume and the subsurface layers, such that:

$${u}_{waves} ( z ) = {{U}_{max , waves} ( \frac{z}{{H}_{p}} )}^{m}$$

$${u}_{OSC} ( z ) = {{U}_{max , OSC} ( \frac{z}{{H}_{p}} )}^{1 / m}$$

With m is the power of the velocity profile, here m=4, and Hₚ is the thickness of the plume layer. The maximum values U_{max,OSC} and U_{max,waves} at the surface may be determined by computing the integral from the surface to the interface between plume and subsurface layer of each velocity profile as follows:

$${U}_{max , OSC} = {U}_{OSC} \frac{1 + m}{m}$$

$${U}_{max , waves} = {U}_{waves} ( 1 + m )$$

where U_{OSC} and U_{waves} are the mean velocities, over the thickness of the plume layer, of each current, computed in step 330 above.

The shear stress profile according to depth within the plume layer can be computed based on the velocity profile by computing a derivative with respect to depth of the velocity profile of the currents:

$$τ ( z ) = k \frac{\partial u ( z )}{\partial z} ,$$

where k is a calibration constant, for instance equal to 0.1.

$${τ}_{waves , plume} ( z ) = {{τ}_{0 , waves} ( \frac{z}{{H}_{p}} )}^{m - 1}$$

$${τ}_{OSC , plume} ( z ) = {{τ}_{0 , OSC} ( \frac{z}{{H}_{p}} )}^{1 / m - 1}$$

$$where {τ}_{0 , waves} = {U}_{waves} \cdot \frac{k \cdot m \cdot ( 1 + m )}{{H}_{p}} and {τ}_{0 , OSC} = {U}_{OSC} \cdot \frac{k \cdot ( 1 + m )}{{H}_{p} \cdot {m}^{2}} .$$

$$\vec{{τ}_{wic , plume}} ( z ) = \vec{{τ}_{waves , plume}} ( z ) + \vec{{τ}_{OSC , plume}} ( z )$$

The directions of the shear stresses induced by the wave-current and the ocean surface currents, respectively, is the same as the direction of the respective velocity vectors.

In the subsurface layer,

Once the shear stress profile is obtained, computing its average along the vertical axis enables obtaining a mean value of the shear stress induced by the wind-induced currents within the plume layer. Further, the directions of the shear stresses induced by the wave-current and the ocean surface currents, respectively, is the same as the direction of the respective velocity vectors:

$$\vec{{τ}_{wic , plume}} = \vec{{τ}_{0 , OSC}} \cdot m + \vec{{τ}_{0 , waves}} \cdot \frac{1}{m}$$

Regarding computation of a shear stress value incurred by the wind-induced currents within the subsurface and bottom layers, as these currents extend in an opposite direction in the subsurface layer and in the plume layer, it is considered that the velocity of these currents is null at the interface plume/subsurface layer (z=Hₛ=H_{sub}+H_{bot} where H_{bot} is the thickness of the bottom layer and H_{sub} is the thickness of the subsurface layer) and also null on the ground, and the velocity reaches a maximum between those two null points. The velocity profile in the subsurface and bottom layers u_{sub}(z) can thus be written as a sum of velocity profiles occurring within the subsurface and bottom layers, where the velocity profiles are power law profiles of opposite signs with respectively m and 1/m exponents: u_{sub}(z)=u₁(z)+u₂(z)

$${u}_{1} ( z ) = {{U}_{max , 1} ( \frac{z}{{H}_{s}} )}^{m}$$

$${u}_{2} ( z ) = {{U}_{max , 2} ( \frac{z}{{H}_{s}} )}^{1 / m}$$

where u₁(z) designates is a first velocity profile of this decomposition, U_{max,1} is the corresponding maximum velocity, u₂(z) designates the second velocity profile of this decomposition, and U_{max,2} is the corresponding maximum velocity.

Computing the integral between the plume/subsurface boundary and the ground of the velocity profile, and considering the null boundary conditions, allows obtaining the two constant parameters U_{max,1} and U_{max,2}:

$${U}_{max , 2} = - {U}_{max , 1} = {U}_{wic , sub} \frac{1 + m}{m - 1}$$

where U_{WIC,sub} is the mean velocity of return currents in the subsurface layer computed above.

The shear stress profile according to depth within the subsurface and bottom layers of the return currents can be computed by computing the derivative of the current velocity profile in the subsurface layer:

$$\vec{{τ}_{sub}} ( z ) = \vec{{τ}_{1}} ( z ) + \vec{{τ}_{2}} ( z ) = \vec{{τ}_{0 , 1}} \cdot {( \frac{z}{{H}_{s}} )}^{m - 1} + \vec{{τ}_{0 , 2}} \cdot {( \frac{z}{{H}_{s}} )}^{1 / m - 1}$$

$$with \vec{{τ}_{0 , 1}} = \vec{{U}_{sub}} \cdot \frac{k \cdot m \cdot ( 1 + m )}{{H}_{s} ( m - 1 )} and \vec{{τ}_{0 , 2}} = - \vec{{U}_{sub}} \cdot \frac{k \cdot ( 1 + m )}{{H}_{s} ( m - 1 ) \cdot m} .$$

Once the shear stress profile is obtained, the mean shear stress induced by return currents within the subsurface layer, i.e., from the interface between the bottom and subsurface layers (z=H_{bot}) and the interface between the subsurface and plume layers (z=Hₛ), can be computed as:

$$\vec{{τ}_{wic , subsurface}} = \{ \begin{matrix}\frac{1}{1 - {z}_{b}} ( \vec{\frac{{τ}_{0 , 1}}{m}} ( 1 - 2 {a}^{m} + {z}_{b}^{m} ) + m \cdot \vec{{τ}_{0 , 2}} ( 1 - 2 {a}^{\frac{1}{m}} + {z}_{b}^{\frac{1}{m}} ) ) & if a \geq {z}_{b} \\ \frac{1}{1 - {z}_{b}} ( \vec{\frac{{τ}_{0 , 1}}{m}} ( 1 - {z}_{b}^{m} ) + m \cdot \vec{{τ}_{0 , 2}} ( 1 - {z}_{b}^{\frac{1}{m}} ) ) & if a \leq {z}_{b}\end{matrix}$$

$$with$$

$${z}_{b} = \frac{{H}_{bot}}{{H}_{s}}$$

$$and$$

$$a = {( \frac{1}{m} )}^{\frac{m}{{m}^{2} - 1}} .$$

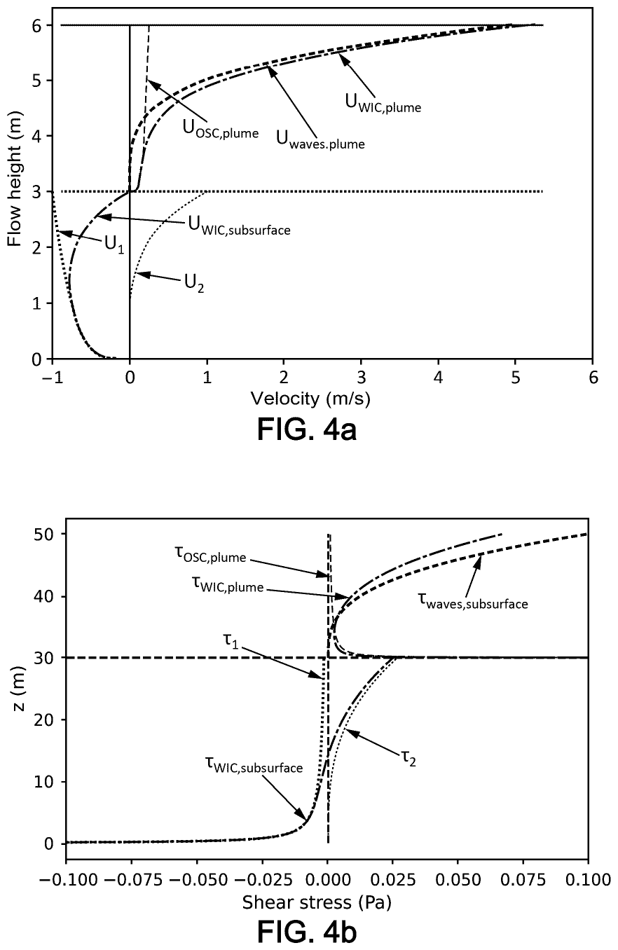

The velocity profiles of the wind-induced currents within the plume and subsurface layers are shown in FIG. 4a, and the shear stress profiles induced by said currents within the same water layers are shown in FIG. 4b.

As the bottom layer corresponds to the boundary limit of the subsurface layer's flow, a mean shear stress value in said layer is computed by the mean of the shear stress profile between the ground (z=0) and the top of the bottom layer, i.e., the interface between the bottom and subsurface layers (z=H_{bot}), and is equal to (considering only return currents of wind-induced currents):

$$\vec{{τ}_{wic , bottom}} = \{ \begin{matrix}\frac{1}{{z}_{b}} ( \vec{\frac{{τ}_{0 , 1}}{m}} {z}_{b}^{m} + m \cdot \vec{{τ}_{0 , 2}} {z}_{b}^{\frac{1}{m}} ) & if a \geq {z}_{b} \\ \frac{1}{{z}_{b}} ( \vec{\frac{{τ}_{0 , 1}}{m}} ( {z}_{b}^{m} - 2 {a}^{m} ) + m \cdot \vec{{τ}_{0 , 2}} ( {z}_{b}^{\frac{1}{m}} - 2 {a}^{1 / m} ) ) & if a \leq {z}_{b}\end{matrix}$$

Regarding the tidal current and river-mouth current, their velocity profile according to water depth is also assumed to be a power function with a 1/m exponent, but said velocity profile extends over all the water depth from surface to bottom:

$${u}_{river} ( z ) = {{U}_{max , river} ( \frac{z}{WD} )}^{1 / m}$$

$${u}_{tidal} ( z ) = {{U}_{max , tidal} ( \frac{z}{WD} )}^{1 / m}$$

The maximum values U_{max,river} and U_{max,tidal} at the surface may be determined by computing the integral from the surface to the interface between plume and subsurface layer of each velocity profile:

$${U}_{max , river} = {U}_{river} \frac{1 + m}{m}$$

$${U}_{max , tidal} = {U}_{tidal} \frac{1 + m}{m}$$

Uᵣᵢᵥₑᵣ is equal to ū defined in WO 2020/229865. U_{tidal} corresponds to the value of velocity E_{tc,plume} of the tidal current defined in WO 2020/229866.

The shear stress profile is then a derivative of the velocity profile according to z:

$$\vec{{τ}_{river}} ( z ) = {\vec{{τ}_{0 , river}} ( \frac{z}{WD} )}^{1 / m - 1}$$

$$\vec{{τ}_{tidal}} ( z ) = {\vec{{τ}_{0 , tidal}} ( \frac{z}{WD} )}^{1 / m - 1}$$

$$where$$

$$\vec{{τ}_{0 , river}} = \vec{{U}_{river}} \cdot \frac{k \cdot ( 1 + m )}{WD \cdot {m}^{2}}$$

$$and$$

$$\vec{{τ}_{0 , tidal}} = \vec{{U}_{tidal}} \cdot \frac{k \cdot ( 1 + m )}{WD \cdot {m}^{2}}$$

The shear stress vector in each water layer can then be inferred by this profile by integrating the shear stress profile between the limits of each current, and the direction of the vector is provided by the direction of the velocity vector of the corresponding current.

Finally, the total shear stress vectors in the plume and in the subsurface layers are the sums of the shear stress vectors resulting from each simulated current in the corresponding layer.

Additionally, a specificity of the bottom layer is that the sediments are not only submitted to a shear stress induced by the flowing currents, but also to gravity, leading to take into account a gravity component of the shear stress within the bottom layer. This component depends on the topographic slope of the ground surface but also on proprieties of the sediments. Accordingly:
if the slope is null, the shear stress induced by the gravity is null;
the value of the shear stress induced by gravity on the particle is equal to a deposition shear stress threshold when the current velocity in the subsurface layer is null and the topographic slope of the ground surface is superior or equal to an avalanche angle determined for the particle; and
the direction of the shear stress induced by gravity on the particle is parallel to the direction of the downward topographic slope of the water bottom.

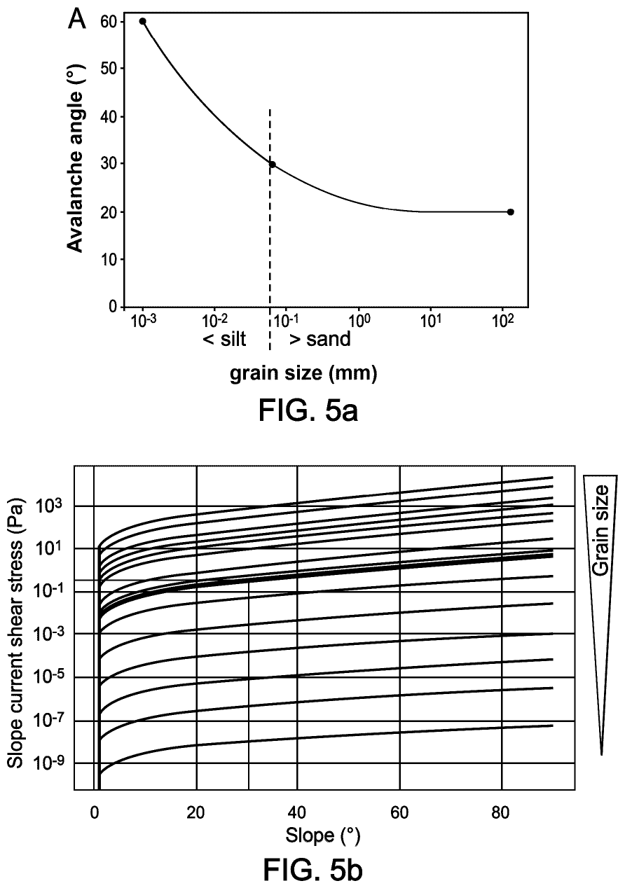

The gravity-induced shear stress applied to a particle of granulometry gr is computed as follows:

$$\vec{{τ}_{slope , gr}} = \frac{1}{e - 1} ( exp ( \frac{α}{{α}_{Cr} ( gr )} ) - 1 ) \cdot {τ}_{Cr} \cdot \vec{slope}$$

where α is the topographic slope, α_{Cr} is the avalanche angle, i.e., the critical slope of the particles, depending on their granulometry as shown in FIG. 5a, τ_{Cr} is the critical shear stress of deposition of the particles, and \vec{slope} is the direction of the descending slope. FIG. 5b shows the gravity-induced shear stress as a function of granulometry.

The total shear stress within the bottom layer applied to particle of granulometry gr is therefore equal to:

$$\vec{{τ}_{bottom}} = \vec{{τ}_{bottom , Cur}} + \vec{{τ}_{slope , gr}}$$

Back to FIG. 1, once the shear stress has been computed, the method further comprises a step 500 of introducing at least one particle of sediments in at least one cell of the geological gridded model. The number of particles introduced at step 500, the type of elements and their granulometric class, depend on the supply or production model defined at setup step 90.

The location, within the model, where the particles are introduced depends on the source of the particles. For instance, regarding clastic supply processes such as river mouth or volcano, the location of the source of particle is set during the setup step. Regarding in-situ production of carbonates, said production may occur in any cell where the conditions enabling the production are met. For instance, if a production function is associated with conditions on water depth, the production may occur only in the cells of the model in which the water depth satisfies the conditions.

The depth at which the particles are introduced also depend from the process they originate from and the granulometric class of the particle. Accordingly, particles originating from:
mineral sources causing deposit of travertine; or
in-situ production of carbonates, are introduced at the water bottom, immediately deposited, and may be remobilized when stormy events are simulated, as explained in greater details below. On the other hand, particles originating from a river mouth can be introduced in various water layers as detailed in WO2020/229865.

The method then comprises a step 600 of determining a transport of the particles of siliciclastic sediments introduced in the geological gridded model, based on the water-currents induced shear stress. The transport may comprise displacing a particle from a cell to a neighboring cell and/or depositing the particle.

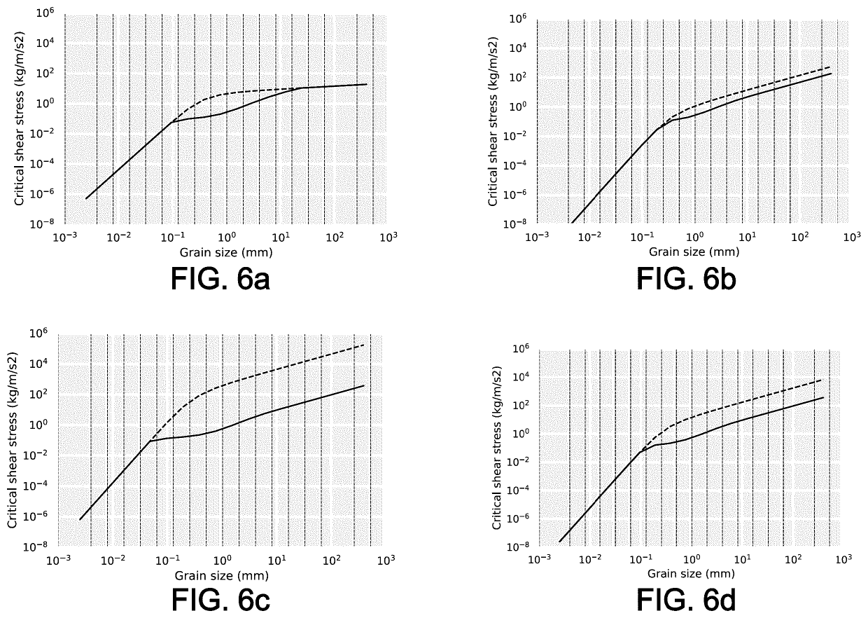

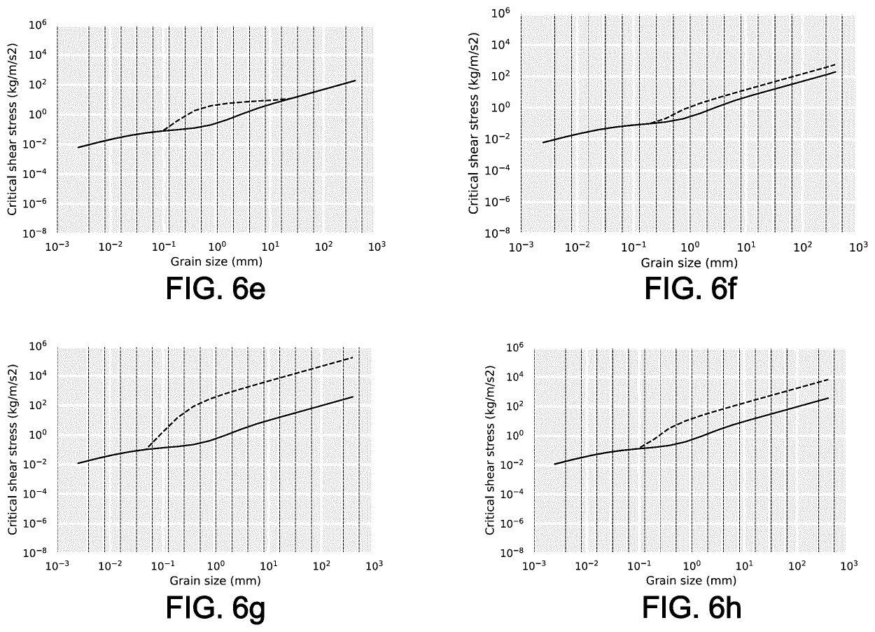

FIGS. 6a to 6d represent Shields diagrams for deposition of particles, expressing the shear stress values for transport and deposition of sediments according to their grain diameter. FIG. 6a relates to porous flat carbonates, FIG. 6b relates to porous spherical carbonates, FIG. 6c relates to non-porous spherical carbonates, and FIG. 6d relates to clast. The transport of a particle may be either a transport by traction or a transport by suspension. In FIGS. 6a to 6d, the area under the solid line corresponds to a zone where the particles are not transported, the area between the solid line and the dotted line corresponds to a zone where the particles are transported by traction, and the area above the dotted line corresponds to a zone where the particles are transported by suspension. The solid line thus corresponds to a traction shear stress threshold, and the dotted line corresponds to a suspension shear stress threshold. The determination of the transport mode of a particle depends on the shear stress induced on the particle at the water level where the particle is located and on the shear stress thresholds which depend on the particle, and which are represented by the lines of the Shields diagram.

Accordingly, the step of transporting and/or depositing a particle is performed as follows:
if the particle is located in the plume or subsurface layer:
   if the shear stress value in the water layer in which the particle is located is higher than the suspension shear stress threshold, the particle is transported to an adjacent cell, said adjacent cell being determined based on the determined direction shear stress, and the particle remains within the same water layer; and
   if the shear stress induced on the particle is lower than the suspension shear stress threshold, the particle is transported downwards, i.e., to the subsurface layer if the particle is originally in the plume layer, or in the bottom layer if the particle is originally in the subsurface layer, while remaining within the same cell; and
if the particle is located in the bottom layer:
   if the shear stress induced on the particle is higher than a traction shear stress threshold, the particle is transported to an adjacent cell, said adjacent cell being determined based on the determined direction of the shear stress within the bottom layer, and remains within the bottom layer; and
   if the shear stress induced on the particle is lower than the traction shear stress threshold, the particle is deposited on the ground surface.

In embodiments, the transport step 600 may comprise a preliminary substep 601 of modelling aggregation of particles by flocculation. Flocculation is a process by which fine-grain particles are electrically charged, which lead them to being gathered together due to Van des Waals forces. If flocculation is modelled, then preferably every implementation of the transport step includes said preliminary substep of modelling flocculation.

Accordingly, a fraction of flocculated particles is computed based on a plurality of controlling factors including at least the particle size and the current-induced shear stress occurring within the considered layer of water. The controlling factors preferably also comprise salinity and the concentration of suspended sediments, the latter being computed in each cell as V_{particle}/V_{water} where V_{particle} is the total volume of particles present in the cell (resulting from introduction and/or transport of particles into the cell) and V_{water} is the volume of water in the cell, which is computed from the side length of the cell and the water depth in the cell.

In embodiments, the fraction of flocculated particles may be computed based on the following function:

$${F}_{floc} = T \cdot ( {F}_{floc , 0} + ( 1 - {F}_{floc , 0} ) \cdot {\prod }_{controlling factors} {F}_{i} )$$

where F_{floc,O} is a background flocculation fraction, i.e., a proportion of particles which flocculate no matter the values of the controlling factors. It is a constant value which may be user-defined, and for instance set to 0. Fᵢ is a controlling factor function expressing a flocculation fraction in % according to a value of the corresponding controlling factor.

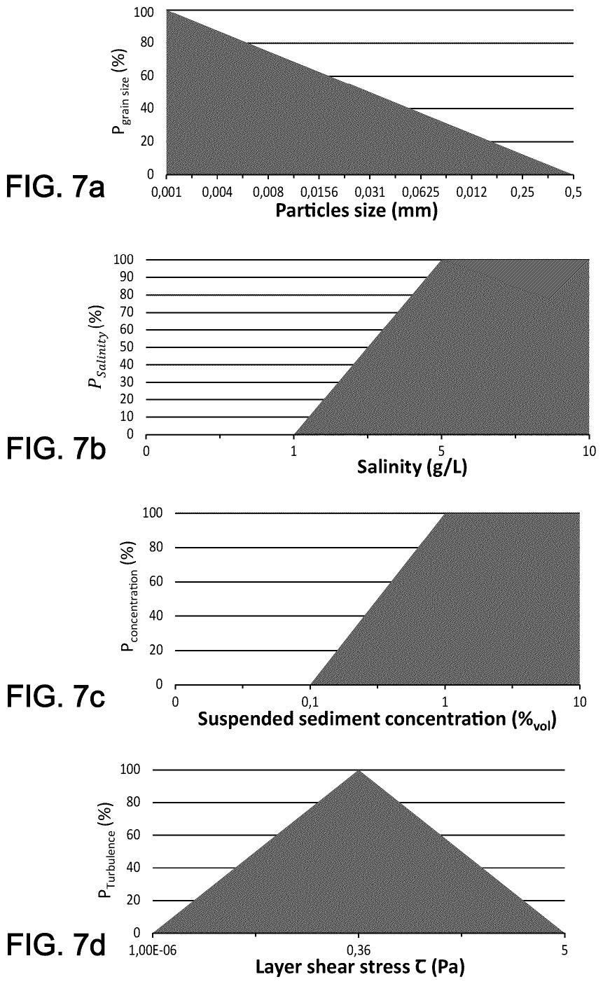

With reference to FIGS. 7a to 7d are shown exemplary controlling factors functions. As shown in FIG. 7a, the fraction of flocculated particles decreases with the size of the particles, but increases with salinity (FIG. 7b) and with the concentration of suspended sediments (FIG. 7c). The fraction of flocculated particles also increases with the current induced layer shear stress until the latter reaches a threshold value (0.36 in FIG. 7d), and then decreases with the shear stress value. The shear stress value is here used as an indicator of the turbulence of the water: a turbulence increase brings together the particles and fosters contact between them; but when turbulence exceeds a threshold the particles no longer aggregate one another.

Flocculation is performed by aggregating the particles two by two starting from the finer ones, until the amount of aggregated particles reaches the fraction F_{floc}. For a considered particle, the particle that is aggregated to it is randomly cast according to the granulometric distribution of the particles. The result is a flocculated particle which size is the sum of the sizes of the two aggregated particles.

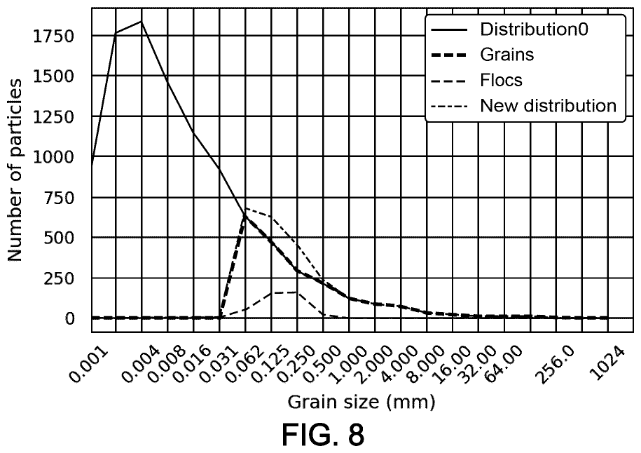

On FIG. 8 is shown an example of initial distribution of introduced particles at step 500 and the result of the flocculation process on said distribution.

Step 600 of transporting and/or depositing particles is iterated until all particles are deposited or have exiting the model.

When the modelling method includes simulation of stormy events, the method may further comprise a step 700 of modelling remobilization of a fraction of the particles deposited at step 600, following occurrence of stormy events. During implementation of step 700, only a fraction of the particles deposited during the same computation layer, corresponding to the same time-period, are remobilized. The particles deposited during a previous computation layer corresponding to a previous time-period are not remobilized.

Modelling remobilization 700 of a fraction of deposited particles comprises determining 710 a shear stress induced on the deposited particles during a stormy event and determining a fraction of the deposited particles which is remobilized, as well as the water current 720 in which the particles are remobilized particles.

Determining the shear stress induced on the deposited particles during a stormy event 710 involves determining a velocity and a direction of at least one wind-induced current occurring within the modelled area during a stormy event. This step can be performed according to the description of step 300 above, except that the celerity vector of the wind is the vector \vec{u_{w,storm}} assigned to stormy event, which is different from the celerity vector of the wind \vec{u_{w}} in fair weather conditions, i.e., the speed is greater and the direction may vary. When other currents are modelled during step 400, the same currents may also be modelled for stormy events, and a resulting current may be computed from the sum of modelled currents.

A shear stress value and direction imparted by the currents on the deposited particles, i.e., a shear stress value imparted by the currents in the bottom layer of the cells, is then computed in the same manner as step 400 disclosed above.

The fraction of remobilized particles of a given grain size gr is then computed as follows:

$${Frac}_{remobilized}^{gr} = \{ \begin{matrix}0 & if {τ}_{Bottom} \leq {τ}_{threshold , min}^{gr} \\ {t}_{f} \cdot \frac{{τ}_{Bottom} - {τ}_{threshold , min}^{gr}}{{τ}_{threshold , max}^{gr} - {τ}_{threshold , min}^{gr}} & if {τ}_{threshold , min}^{gr} \leq {τ}_{Bottom} \leq {τ}_{threshold , max}^{gr} \\ {t}_{f} & if {τ}_{Bottom} \geq {τ}_{threshold , max}^{gr}\end{matrix}$$

where τ_{threshold,min}^{gr} and τ_{threshold,max}^{gr} are shear stress thresholds of the deposited particles which may be defined by the user. t_{f} is a time factor defined as:

$${t}_{f} = \{ \begin{matrix}\frac{{t}_{storm}}{{t}_{max}} & if {t}_{storm} \leq {t}_{max} \\ 1 & if {t}_{storm} > {t}_{max}\end{matrix}$$

and tₘₐₓ is a parameter from which the time factor tris equal to 1. tₘₐₓ can for instance be set at 10 days/year.

If the shear stress induced by the currents in the bottom layer is lower than the minimum shear stress threshold value τ_{threshold,min}^{gr}, then no particles are remobilized.

When particles are indeed remobilized (Frac_{remobilized}≠0), the water layer in which the particles are remobilized is determined 720 based on the shear stress value induced by the currents in at least the bottom layer—possibly in both the bottom and the subsurface layers, and possibly in each layer—and at least one characteristic shear stress value of the considered particle:
the fraction of remobilized particle is integrally remobilized in the bottom layer if the shear stress value induced by the currents in the bottom layer is greater than the critical motion shear stress value of the particles, but if the shear stress value induced by the currents in the subsurface layer is lower than a critical suspension shear stress value of the particles:
   if τ_{BOTTOM}>τ_{Cr,motion} and τ_{SUBSURFACE}≤τ_{Cr,suspension}
   then 100% of Frac_{remob} is remobilized in bottom layer
if the shear stress value induced by the currents in the subsurface layer is greater than the critical suspension shear stress value of the particles, and the shear stress value induced by the currents in the plume layer is lower than said critical suspension shear stress value, a part of the remobilized fraction of particles is remobilized in the subsurface layer and the rest is remobilized in the bottom layer:
if τ_{BOTTOM}>τ_{Cr,motion} and τ_{SUBSURFACE}>τ_{Cr,suspension} and τ_{PLUME}≤τ_{Cr,suspension}
   then a suspended fraction Fₛᵤₛₚ is remobilized in the subsurface layer
      if the shear stress values induced by the currents in both the subsurface and the plume layer are greater than the critical suspension shear stress value of the particles, then part of the remobilized suspended fraction of particles is remobilized in the plume layer and the rest is remobilized in the subsurface layer:

if τ_{BOTTOM}>τ_{Cr,motion} and τ_{SUBSURFACE} τ_{Cr,suspension} and τ_{PLUME}>τ_{Cr,suspension}

then a fraction Fₚₗᵤₘₑ of the suspended fraction Fₛᵤₛₚ is remobilized in the plume layer and 1−Fₚₗᵤₘₑ is remobilised in the subsurface layer

In the second situation recited above, the fraction of suspended particles may be computed as:

$${F}_{susp} = \{ \begin{matrix}\frac{{τ}_{SUBSURFACE} - {τ}_{Cr , suspension}}{{τ}_{SUBSURFACE} - {τ}_{Cr , motion}} & if {τ}_{Cr , suspension} \geq {τ}_{Cr , motion} \\ \frac{{τ}_{SUBSURFACE} - {τ}_{Cr , suspension}}{{τ}_{Cr , motion} - {τ}_{Cr , suspension}} & if {τ}_{Cr , suspension} < {τ}_{Cr , motion}\end{matrix}$$

In the third situation recited above, part of the fraction of suspended particles is remobilized in the plume layer and may be computed as:

$${F}_{plume} = \frac{{H}_{plume}}{{H}_{plume} + {H}_{sub}} \cdot {F}_{susp}$$

The remainder is remobilized in the subsurface layer:

$${F}_{subsurface} = 1 - {F}_{plume}$$

With reference to FIGS. 6e to 6h, representing Shields diagrams expressing the shear stress values for remobilization of clastic and carbonates sediments according to their grain diameter, the critical motion shear stress depends on the grain diameter of the particle and can be determined using said Shields diagram. FIG. 6e relates to porous flat carbonates, FIG. 6f relates to porous spherical carbonates, FIG. 6g relates to non-porous spherical carbonates and FIG. 6h relates to clast. In these figures, the zone below the solid line is a zone where the particles are not remobilized, the zone between the solid line and the dotted line is a zone where the particles are remobilized by traction (i.e., in the bottom layer) and the zone above the dotted line corresponds to a remobilization by suspension. The solid line thus corresponds to a critical motion shear stress and the dotted line corresponds to a critical suspension shear stress. It should be underlined that for fine grains, for instance silt, fine sand or clay particles, there is no distinction between the critical suspension shear stress and the critical motion shear stress. As a consequence, these particles are either not remobilized or remobilized. If remobilized, these particles can be transported in the bottom layer if the shear stress value within the subsurface layer is lower than the critical suspension shear stress. Thus the equation for computing Fₛᵤₛₚ above is not applicable.

Last, for each layer, the volume of remobilized sediments during stormy events can be computed from the fraction of sediments remobilized in each layer (Flayer) multiplied by the volume of deposited particles in fair weather conditions V_{sed,depo,fairweather} (step 600):

$${V}_{sed , remobilized , layer} = {F}_{layer} \cdot {V}_{sed , depo , fairweather}$$

In embodiments, the step 700 of remobilizing particles is followed by implementation of a step 600′ of modelling transport and/or deposition of the remobilized particle, which may also include a flocculation substep 601′. Said step 600′ is iterated until all particles are deposited or have exited the model.

Implementation of a step 600′ of modelling transport and/or deposition of particles after remobilization is performed the same way as a step 600 implemented prior to remobilization, except that the shear stresses computed for the modelled currents are computed in stormy conditions, i.e., taking \vec{u_{wind,storm}} as the wind speed vector for computing the velocity and shear stress values corresponding to the wind-induced currents.

The method then comprises a step 800 of recording, in a memory, data relative to the deposited sediments in at least a plurality of cells of the model, and more preferably in at least all the cells of the model where sediments have been deposited.

The recorded data may comprise, for one cell, at least the type(s) of elements that have been deposited and the volume of deposited particles of each element. This enables inferring the relative proportions of deposited elements in each cell. The recorded data may also comprise the granulometry of the recorded elements, which further enables inferring a level of grain sorting of the deposited sediments.

The recorded data also comprise information about the conditions of deposition of the particles. It may comprise a cumulative velocity and/or shear stress induced by the modelled water currents in a cell, and may also comprise the respective velocity and/or shear stress of each modelled current. Recording the velocity of the currents occurring at the time and place of deposition of the sediments may then enable inferring a current structure of the deposited sediments.

The recorded conditions of deposition of the particles may also comprise bathymetry (i.e., water depth of the ground surface at the considered cell), water temperature, water pH, salinity or other chemical parameter at the considered cell. They may also comprise the value of the slope of the ground surface at the considered cell.

If the considered cell is above water level during the computational layer, then the considered cell is considered emerged and a corresponding parameter may be recorded accordingly.

When wind-induced currents are simulated, the value of wave-breaking water depth and wave-base water depths may be recorded along with the water depth at the considered cell. Alternatively, parameters (such as Boolean values) expressing the relative depth of the cell with respect to the wave base and wave breaking water depths may be recorded instead of the wave-base and wave-breaking water depths. The same applies when stormy events have been simulated with wave-base and wave-breaking water depths during stormy events. Also in that case, a record is kept of the elements which have been remobilized during stormy events. This enables recording, for deposited carbonates, whether the corresponding particles have been produced in-situ (no remobilization) or transported (remobilization).

When tidal current is simulated, the recorded data may comprise the values of water level at low tide and high tide respectively and/or a value indicative of the position of the cell with respect to low tide and high tide, i.e., whether the relative height of the ground surface at the cell with respect to the low tide and high tide water levels.

During a step 900, the topography of the geological model of the area is updated to take into account the sediments deposited during the computational layer, i.e., an additional time layer is generated, which thickness is determined based on the volume of deposited sediments during the period of time corresponding to the computational layer. Step 900 may also comprise updating topography according to eustatism and subsidence, i.e., respectively the reference water level and the ground level may be changed by updating the position along z of each cell and the water depth of each cell.

During a step 1100, the method then further comprises associating at least one cell of the model to a kind of sedimentary facies among the sedimentary facies classification and/or a kind of sedimentary environment among the sedimentary environment classification, based on the recorded data. This step may be implemented after the simulation of the deposition of a plurality of time-layers, i.e., after a plurality of iterations of step 1000, based on the data recorded at each iteration. Alternatively, this step may also be implementing during each iteration of step 1000, for instance after step 800 of recording the data, or after step 900 of updating the topography.

In particular, when all the criteria defining one type of sedimentary facies or one type of sedimentary environments are met, the cell is associated to said facies or sedimentary environment.

The type of sedimentary facies may be inferred only from the elements and respective proportions of elements deposited in a cell, or may be inferred using additional information such as the level of grain sorting, a current structure determined based on the water currents velocity in the cell at the time of deposition, and/or presence or absence of emersion traces (presence of emersion traces is fulfilled if the cell has been emerged during at least one iteration).

The type of sedimentary environment is also determined based on the recorded data. When a sedimentary environment comprises conditions relative to the waves, the association step may comprise determining a predetermined location relative to the waves based on the recorded water depth and parameters defining the waves (wave-breaking/wave-based water depths) indicated above.

When a sedimentary environment comprises conditions relative to the tide, the association step may comprise determining a predetermined location relative to the tide based on the recorded height of the cell and the water level at high-tide and low-tide.

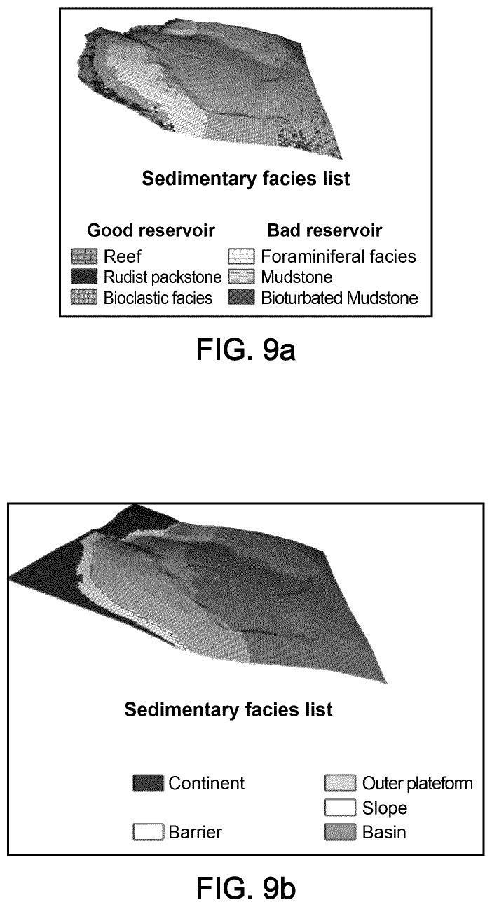

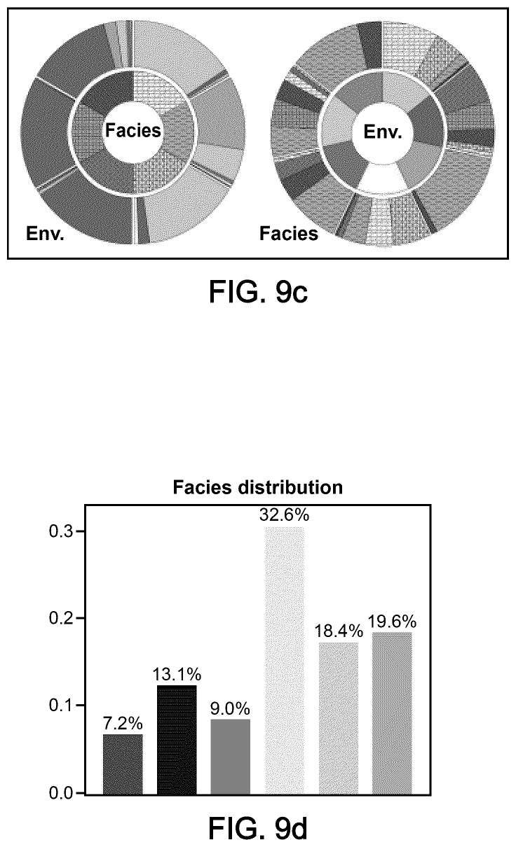

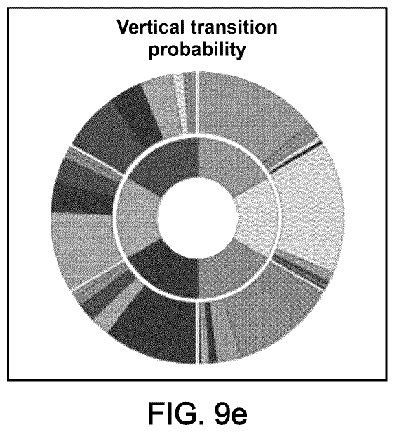

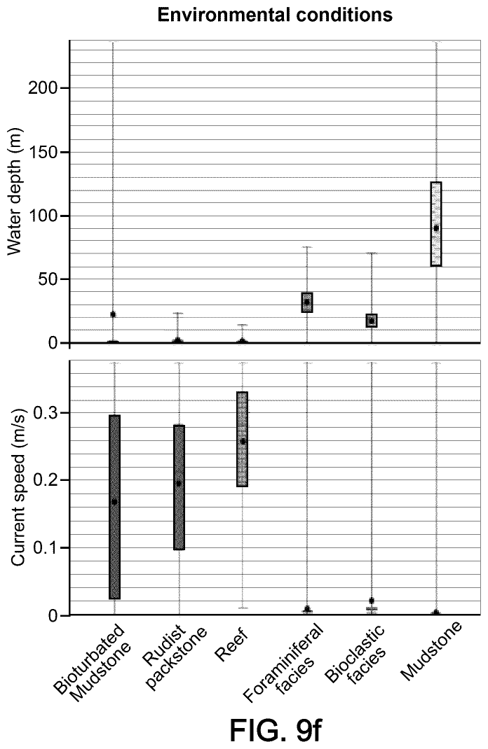

With reference to FIGS. 9a and 9b, the above-disclosed method allows displaying maps representing sedimentary facies or sedimentary environments in four dimensions, comprising three dimensions in space, and time. In FIG. 9a is shown an exemplary 3D representation of the result of a simulation after simulating deposition of a number of layers of sediments, each layer representing a determined period of time. In the representation of FIG. 9a, each pixel has a color representing a respective sedimentary facies. In FIG. 9b is shown an exemplary 3D representation of the result of the same simulation, where each pixel is associated to a color representing a respective sedimentary environment. Accordingly, one may choose to display a three-dimensional representation of the sedimentary facies composing the modelled sedimentary basin at one or a plurality of times (i.e., after a given number of deposited layers of sediments) selected over the period of time covered by the simulation. Similarly, one may also choose to display a three-dimensional representation of the sedimentary environments composing the modelled sedimentary basin at one or a plurality of times selected over the period of time covered by the simulation.

By selecting a subset of the modelled area, in particular a column of cells, it is also possible to extract from the model a simulated facies log that can be compared to a facies log corresponding to a real observed well.

The method may also comprise performing statistical analysis of the sedimentary facies and sedimentary environments in order for instance to perform facies model quality control. For a given type of sedimentary facies, histograms of occurrence of the type of sedimentary facies may be computed and displayed, such as the histogram shown in FIG. 9d exhibiting the relative proportions of sedimentary facies within the model obtained at the end of the simulation and represented in FIG. 9a. The same applies for variograms corresponding to spatial distributions of sedimentary facies over the model.

With reference to FIGS. 9c and 9e, the method may also comprise computing transition probabilities between one sedimentary facies type and another based on the probability of having the two sedimentary facies types associated to adjacent cells, or correlations between one sedimentary facies and a sedimentary environment in a given cell. In FIG. 9c is shown a representation of probability of contingency between sedimentary facies and sedimentary environments, based on the statistics of cells of the model and their associated sedimentary facies and environment. In the left-hand graph of FIG. 9c, the internal ring represents the various facies types encountered in the model, and the external ring represents the proportions of sedimentary environments observed for each facies type. The external ring is divided in a number of angular ranges corresponding to the number of sedimentary facies of the internal ring, and each angular range corresponding to a sedimentary facies is further divided according to the respective proportions of sedimentary environments observed in the pixels corresponding to said facies. In the right-hand graph of FIG. 10c conversely, the internal ring represents the sedimentary environments observed within the model, and the external ring represents the proportions of each sedimentary facies type observed for the considered sedimentary environment.

According to another example shown in FIG. 9e, vertical transition probabilities between two types of sedimentary facies or two types of sedimentary environments may be computed and displayed. FIG. 9e is a representation of the vertical transition probability between two types of sedimentary facies, based on the statistics of two vertically adjacent cells of the model and their associated sedimentary facies. The internal ring of FIG. 9e shows all the sedimentary facies observed in the model and the external ring displays the respective proportion, for each sedimentary facies represented by an angular range of the internal ring, of sedimentary facies that are observed in vertically adjacent pixels.

These computations and representations may enable to correct a facies model or to correct the parameters of the setup of the simulation, especially when a facies log corresponding to an observed well is available for comparison.

The method may also comprise computing and displaying environmental conditions observed for one or more facies. As shown in FIG. 9f, for at least one environmental parameter, a boxplot may be computed representing the range of values of the environmental parameter that is observed for a given sedimentary facies. This may enable correcting the definition of the sedimentary facies classification or sedimentary environment classification.

The various embodiments described above can be combined to provide further embodiments. All of the patents, patent application publications, and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for modelling sedimentary deposition within an immersed area, the method being implemented by a device comprising a computer and a memory, and comprising:
receiving a sedimentary facies classification comprising, for a plurality of sedimentary facies, a list of criteria defining each sedimentary facies, wherein the criteria comprise the elements and respective proportions of each element composing the sedimentary facies;
receiving a sedimentary environment classification comprising, for a plurality of sedimentary environments, a list of environmental parameters conditions defining the sedimentary environment;
simulating the evolution of the topography of an immersed sedimentary area over time, wherein the simulation comprises:
defining:
a model of the immersed sedimentary area comprising a ground surface having a plurality of cells and an initial topography;
a plurality of processes of supply or production of sediments; and
at least one water current to be simulated;
simulating the deposition of at least one layer of sediments on the ground surface within a determined time period comprising:
introducing a plurality of particles of sediments into the model according to the defined supply or production processes;
simulating occurrence of the at least one water current;
determining a transport of at least one particle introduced in the model resulting from the water current, wherein the transport comprises displacing or depositing the particle on the ground surface;
recording data regarding the deposited particles in the memory, the recorded data comprising the type of element, volume and conditions of deposition of the deposited particles; and
updating the topography of the ground surface; and
for at least one cell of a deposited layer of sediments, associating the cell to:
a sedimentary facies, based on a comparison between the recorded data and the sedimentary facies classification; and
a sedimentary environment, based on a comparison between the recorded data and the sedimentary environment classification.

2. The method according to claim 1, wherein the list of criteria defining each sedimentary facies further comprises sedimentary features comprising:
a current structure;
a grain sorting; and
presence or absence of emersion traces,
wherein simulating an occurrence of at least one water current comprises determining a velocity of the current in a plurality of cells of the model,
wherein the recorded data further comprises, for a cell, the velocity of each current occurring within the cell, the granulometry of the deposited particles, and a depth with respect to a water level of the cell,
and associating the cell to a sedimentary facies comprises determining a current structure, grain sorting and presence or absence of emersion traces in the cell based on the recorded data.

3. The method according to claim 1, wherein the environmental parameters conditions defining a sedimentary environment comprise a condition on location of the sediments relative to the tide,
wherein at least one modelled current comprises a tidal current,
modelling the tidal current comprises determining a high tide and a low tide water level,
the recorded data for a cell comprise a water depth of the considered cell at high tide and at low tide,
and associating the cell to a sedimentary environment comprises determining a location of the cell relative to the tide based on the recorded data, and inferring the sedimentary environment based on the location.

4. The method according to claim 1, wherein the environmental parameters conditions defining a sedimentary environment comprise a condition on location of the sediments relative to waves,
wherein at least one modelled current comprises a wave-induced current,
modelling the wave-induced current comprises determining a wave base water depth and a wave breaking water depth,
the recorded data for a cell comprise an indication of the water depth in the cell being either:
below wave-breaking water depth;
between wave-breaking water depth and wave base water depth; or
at or above wave base water depth;
and associating the cell to a sedimentary environment comprises determining a location of the cell relative to the waves based on the recorded data and inferring the sedimentary environment from the location.

5. The method according to claim 4, wherein the simulation further comprises simulating stormy events, and comprises defining a duration of stormy weather conditions during the determined time period, the rest of the time period corresponding to fair weather conditions, wherein simulating the deposition of a layer of sediments comprises:
determining wave base water depths and wave breaking water depths in fair weather and stormy conditions;
determining a transport of at least one introduced particle induced by wave-induced water current in fair weather conditions;
modelling remobilization of a fraction of the deposited particles following occurrence of stormy weather conditions; and
determining a transport of the remobilized particles induced by wave-induced water current in stormy weather conditions,
wherein the recorded data further comprise an indication of the water depth in the cell relative to wave base water depths and wave breaking water depths in fair weather and stormy conditions,
and associating the cell to a sedimentary environment comprises determining a location of the cell relative to the waves based on the recorded data and inferring the sedimentary environment from the location.

6. The method according to claim 1, wherein the environmental parameters conditions defining a sedimentary environment comprise a condition on a topographic slope at the location of deposition of the sediments,
and the recorded data for a cell comprises the topographic slope of the ground surface at the cell.

7. The method according to claim 1, wherein the environmental parameters conditions defining a sedimentary environment comprise a condition on a bathymetry of the location of deposition of the sediments,
simulating the deposition of a layer of sediments comprises computing a water depth of a cell based on a water level and the topography of the ground surface, and the recorded data for a cell comprises the water depth,
and associating the cell to a sedimentary environment comprises determining a bathymetry of the cell based on the recorded water depth.

8. The method according to claim 1, wherein the environmental parameters conditions defining a sedimentary environment comprise a condition on energy of water currents occurring at the location of deposition of the sediments,
wherein simulating an occurrence of at least one water current comprises determining a shear stress induced by the at least one water current in a plurality of cells of the model,
the recorded data comprise the shear stress,
and associating the cell to a sedimentary environment comprises determining an energy of water currents in the cell from the recorded shear stress.

9. The method according to claim 1, further comprising computing a spatial distribution of at least one sedimentary facies within the model, based on the cells associated to the sedimentary facies.

10. The method according to claim 9, the method being implemented by a device also comprising a display, and the method further comprises displaying one of a three-dimensional sedimentary facies map and a three-dimensional sedimentary environment map of the model in at least one state corresponding to a respective time.

11. The method according to claim 1 further comprising determining correlation between at least one sedimentary facies and at least one sedimentary environment.

12. The method according to claim 1, further comprising computing transition probabilities between vertically adjacent sedimentary facies within the model.

13. The method according to claim 12, further comprising receiving a facies log corresponding to an observed well and comparing the computed transition probabilities between vertically adjacent facies within the model to the transitions between vertically adjacent facies of the facies log.

14. A computer program product comprising code instructions for implementing the method according to claim 1, when the instructions are executed by a processor.

15. A non-transitory computer readable storage medium, having stored thereon a computer program comprising program instructions, the computer program being loadable into a processor and adapted to cause the processor to carry out, when the computer program is run by the processor, the method according to claim 1.

16. A computing device, comprising:
an input module for receiving:
a sedimentary facies classification comprising, for a plurality of sedimentary facies, a list of criteria defining each sedimentary facies, wherein the criteria comprise the elements and respective proportions of each element composing the sedimentary facies; and
a sedimentary environment classification comprising, for a plurality of sedimentary environments, a list of environmental parameters conditions defining the sedimentary environment;
a simulation module configured for simulating the evolution of the topography of an immersed sedimentary area over time, comprising:
defining:
a model of the immersed sedimentary area comprising a ground surface having a plurality of cells and an initial topography;
a plurality of processes of supply or production of sediments; and
at least one water current to be simulated;
simulating the deposition of at least one layer of sediments on the ground surface within a determined time period comprising:
introducing a plurality of particles of sediments into the model according to the defined supply or production processes; and
simulating occurrence of the at least one water current; and
determining a transport of at least one particle introduced in the model resulting from the water current, wherein the transport comprises displacing or depositing the particle on the ground surface;
a memory configured for recording data regarding the deposited particles in the memory, the recorded data comprising the type, volume and conditions of deposition of the deposited particles; and
a quality control module configured to associate, to at least one cell of a deposited layer of sediments:
a sedimentary facies, based on a comparison between the recorded data and the sedimentary facies classification; and
a sedimentary environment, based on a comparison between the recorded data and the sedimentary environment classification.

17. The computing device according to claim 16, wherein the quality control module is further configured to compute correlations between sedimentary facies and sedimentary environments or environmental parameters conditions defining a sedimentary environment, and the device further comprises a display for displaying the correlations.
